(19) United States
(12) Patent Application Publication
(10) Pub. No.: US 2010/0131651 A1
(43) Pub. Date: May 27, 2010

(54) METHOD AND SYSTEM FOR ADAPTIVE RESOURCE MANAGEMENT FOR FUTURE INTERNET

(75) Inventors: Sangjin JEONG, Daejeon-city (KR); Myung Ki SHIN, Daejeon-city (KR); Yong-Woon KIM, Seobuk-gu (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunication Research Institute, Daejeon (KR)

(21) Appl. No.: 12/567,055

(22) Filed: Sep. 25, 2009

(30) Foreign Application Priority Data
Nov. 24, 2008 (KR) 10-2008-0117054

(51) Int. Cl. G06F 15/173

(52) U.S. Cl. 709/226

(57) ABSTRACT

When a virtual network environment is established using resources on a network in order for a user to perform an arbitrary test service in the future Internet that is emerging as a replacement of the current Internet, resources having characteristics desired by the user are selected from among a number of resources on the network, and a resource capable of exhibiting an optimum performance is effectively selected from the selected resources.

### CROSS-REFERENCE TO RELATED PATENT APPLICATION

This application claims the benefit of Korean Patent Application No. 10-2008-0117054, filed on Nov. 24, 2008, in the Korean Intellectual Property Office, the disclosure of which is incorporated herein in its entirety by reference.

### BACKGROUND OF THE INVENTION

1. Field of the Invention

At least one embodiment of the present invention relates to a method and system for adaptively managing resources in the future Internet.

2. Description of the Related Art

Currently, the Internet uses a network based on a transmission control protocol/Internet protocol (TCP/IP) developed in the 1970s. Thus, it is difficult for the current Internet to satisfy various users' requirements and to use various applications that have recently been developed, and there are limits due to network advancements and the like.

A demand for a future Internet that overcomes the limits of the current Internet is increasing. Efficient management is required to accomplish optimum performance of the future Internet. However, at present, a technique of arbitrarily allocating resources satisfying users' requirements without considering the characteristics of the resources is being developed.

The present invention tries to solve concentration of overload on specific resources caused by an arbitrarily-developed future Internet and thoughtless unplanned management of network resources of the future Internet.

To solve these problems, a method of providing the future Internet with an adaptive resource management function with respect to scattered resources by variously considering users' requirements related to resources on the future Internet in all layers ranging from Layer 1 to Layer 7 is required.

### SUMMARY OF THE INVENTION

The future Internet denotes a new Internet (namely, a clean-state Internet) that overcomes problems of the current Internet and that is newly designed and established on the basis of requirements for new services that can be generated in the future.

In addition, the future Internet may include a future networking infrastructure, an application service infrastructure, and related core technology which are newly designed in consideration of not only the limits of existing Internet technology but also the limits of the current Internet and future service requirements.

Current research into the future Internet is achieved by development of a creative new service based on a future Internet infrastructure, research into a software structure for realizing future Internet core technology, development of a future Internet platform, development of terminals for the future Internet and components, and the like. Testing and authentication of various innovative future Internet structure proposing technologies are simultaneously performed. Research into test infrastructure establishment that allows execution of a test service with respect to an extensive number of users is also under way.

One of the most important features of the future Internet is a network virtualization technique in which a virtual network is established to freely share all of the resources on a network and provide arbitrary services required by a user by using the resources.

To achieve network virtualization, it should be possible to provide an optimized virtual network by selecting resources conforming to a user's requirements, from among a number of resources existing in the future Internet. In particular, efficient management that allows allocated wireless resources to exhibit optimum performance is required to provide various wireless services.

To achieve efficient management, optimized resources that can satisfy quality of service (QoS) requirements at minimal costs should be selected in collective consideration of requirements of a user, the characteristics of various test services that the user desires to perform, the states of resources that can be allocated (namely, the characteristics of Layer1 through Layer7), and the like.

The present invention provides a method of managing optimal resources within user-affordable costs (namely, a resource ticket) in consideration of the states of future network resources, the characteristics of services, and users' requirements.

According to an aspect of the present invention, there is provided a method of adaptively managing resources in the Internet, the method including ascertaining users' requirements, service characteristics, and resource states and arranging the users' requirements, the service characteristics, and the resource states in priority order; calculating a resource performance index by reflecting the arranged status of the users' requirements, the service characteristics, and the resource states, wherein the resource performance index represents a maximum performance capable of being exhibited by each of a plurality of resources on a network; and allocating resources by comparing a user resource ticket with the resource performance index, wherein the user resource ticket represents a cost that can be afforded by the user for resource usage.

According to another aspect of the present invention, there is provided a server for adaptively managing resources in the Internet, the server including a collection unit collecting information about users' requirements, service characteristics, and resource states and setting the users' requirements, the service characteristics, and the resource states according to a priority order; an optimal resource selection unit calculating a resource performance index representing a maximum performance capable of being exhibited by each of a plurality of resources on a network, according to a resource management algorithm based on the information collected by the collection unit; and an optimal resource allocation unit allocating resources by comparing a resource ticket possessed by a user, which represents a cost that can be afforded by the user, with a value of the resource performance index.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an adaptive resource management system for the future Internet, according to an embodiment of the present invention;

FIG. 2 is a flowchart of a resource allocating method performed in a resource management server included in the adaptive resource management system illustrated in FIG. 1; and

FIG. 3 is a flowchart of a procedure of selecting optimal resources that satisfy users' requirements and service characteristics in the future Internet.

### DETAILED DESCRIPTION OF THE INVENTION

The present invention will now be described more fully with reference to the accompanying drawings, in which exemplary embodiments of the invention are shown. Like reference numerals in the drawings denote like elements. In order to clarify the spirit of the invention, descriptions of well known functions or constructions may be omitted.

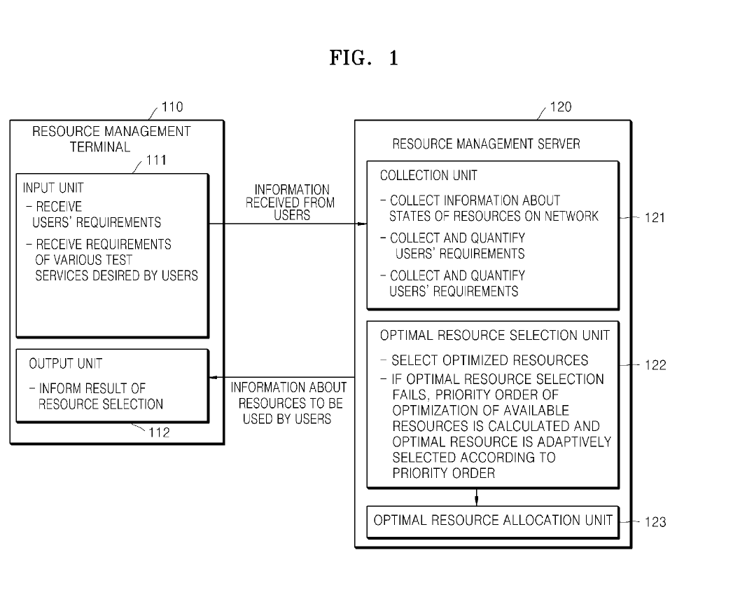

FIG. 1 is a block diagram of an adaptive resource management system for the future Internet, according to an embodiment of the present invention.

Referring to FIG. 1, the adaptive resource management system is roughly divided into a resource management terminal 110 and a resource management server 120. The resource management terminal 110 may be a computer, a hand-held device, a terminal, a mobile phone, or the like, and may be provided to apparatuses in a form such as a portal site or may be represented as various types of applications. The present invention is not limited thereto, and the resource management terminal 110 may be implemented as any shape.

The resource management terminal 110 includes an input unit 111 which receives a user's requirements, characteristics of various test services that the user desires to perform, and an available resource ticket of the user, and an output unit 112 which provides monitoring information about the states of allocated resources to the user.

The resource management terminal 110 transmits information received from a user to the resource management server 120 via the input unit 111, and shows information about resources to be used by the user, which is received from the resource management server 120, to the user via the output unit 112.

The resource management server 120 analyzes the information received from the resource management terminal 110 and the states of resources on a network and allocates resources optimized for test services of the user.

The resource management server 120 includes a collection unit 121, an optimal resource selection unit 122, and an optimal resource allocation unit 123.

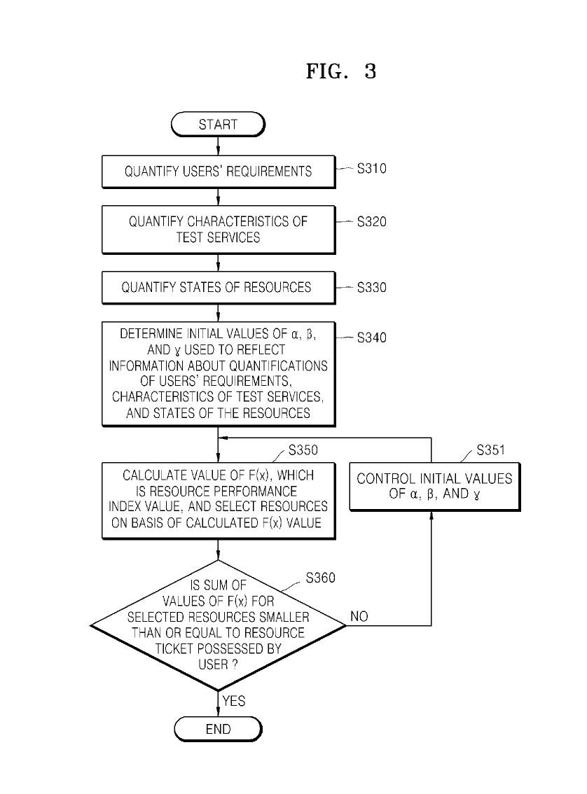

The collection unit 121 collects information about the states of the resources on the network. The collection unit 121 also collects information about users' requirements, service characteristics, and resource performances, and quantifies these collected pieces of information (see operations S310 through S330 of FIG. 3).

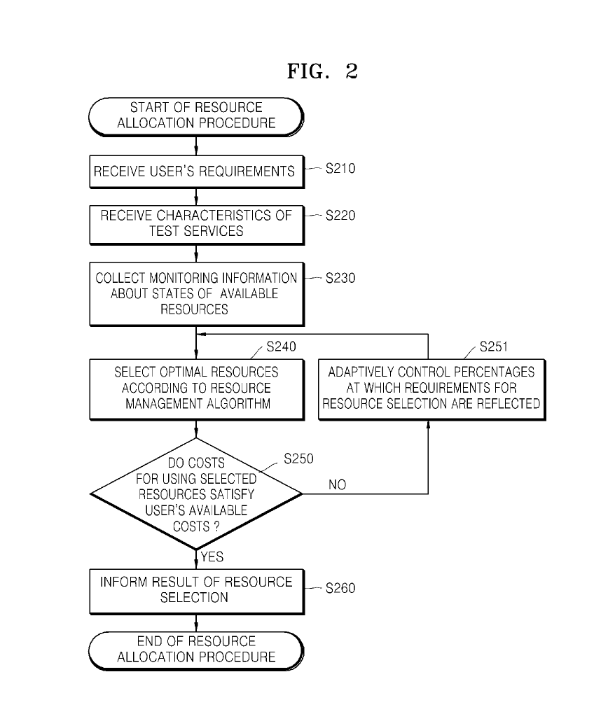

The optimal resource selection unit 122 selects optimized resources on the basis of the pieces of information collected by the collection unit 121, according to a resource management algorithm. If the optimized resource selection fails, the priority order of optimization of available resources is calculated, and optimized resources are adaptively selected according to the calculated priority order and allocated. The resource allocation performed in the resource management server 120 will be described later in greater detail with reference to FIGS. 2 and 3.

The optimal resource allocation unit 123 is connected to the resources selected by the optimal resource selection unit 122 and thus allocates the resources to the user.

As described above, examples of the information received from the resource management terminal 110 include user's requirements (for example, quality of service (QoS) requirements), the characteristics of various test services that the user desires to perform (for example, from characteristics of a physical layer, Layer 1, to characteristics of an application layer, Layer 7), available resource tickets of the user, mean time to failure (MTTF) of resources, and the time when the user is to use resources.

The resource ticket denotes an available budget that a user has. When a service provider defines a cost required to use each resource, a user selects resources within his or her own available resource ticket. In other words, a sum of costs required to use resources may not exceed the user's own available resource ticket.

Examples of the characteristics of various test services may include a maximum/minimum/average delay, a maximum/minimum/average bandwidth, and a maximum/minimum/average loss between the resources, a cost for resource usage, and a time when resources can be allocated. Not only the examples particularly illustrated above but also information naturally deduced to embody the present invention may be received from the resource management terminal 110.

FIG. 2 is a flowchart of a resource allocating method performed in the resource management server 120 included in the adaptive resource management system illustrated in FIG. 1.

The resource management server 120 sets allocatable resources by performing a resource management algorithm in consideration of user's requirements and service requirements. When the allocatable resources are selected, the resource management server 120 transmits a result of the selection of the allocatable resources to the resource management terminal 110 so as to receive a final confirmation from the user.

Examples of the user's requirements may include pieces of information received from the user, such as QoS requirements, the available resource tickets of the user, the MTTF of resources, and the time when the user is to use resources.

Examples of the service requirements may include a maximum/minimum/average delay, a maximum/minimum/average bandwidth, and a maximum/minimum/average loss between the resources, costs for resource usage, and a time when resources can be allocated.

In operation S210, a user's requirements are received from the user. In operation S220, the characteristics of test services are received from the user. Here, the characteristics of the test services are input by the user or set as preset values. In operation S230, monitoring information about the states of available resources is collected. The monitoring information about the states of available resources may be ascertained using a conventional network state information providing system or a resource state monitoring system which is to be researched and developed later in the future Internet.

Thereafter, in operation S240, the resource management algorithm selects optimal resources by using an optimization technique by considering the user's requirements and the service requirements. Examples of the resource management algorithm may include a linear-model-based resource selection algorithm and a nonlinear-model-based resource selection algorithm. Other types of resource selection algorithms developed in the future may also be applied to the adaptive resource management system of FIG. 1. An example of a resource management algorithm used in the present invention will be described below in greater detail with reference to FIG. 3.

In operation S250, the result of the resource selection is transmitted to the resource management terminal 110 so that the user may be asked if the costs for using the selected resources satisfy the user's available resource tickets If the costs for using the selected resources satisfy the user's available resource tickets, the user is informed about the result of the resource selection, in operation S260. On the other hand, if the costs for using the selected resources do not satisfy the user's available resource tickets, weights of reflection of the requirements for resource selection are adaptively controlled, in operation S251. The operation S251 will now be described in greater detail with reference to FIG. 3.

FIG. 3 is a flowchart of a procedure of selecting optimal resources that satisfy user's requirements and service characteristics in the future Internet. FIG. 3 illustrates the optimal resource selection performed in FIG. 2 in greater detail. In particular, the operations S241, S250, and S251 are specified.

In the present invention, the priority of available resources is optimally calculated in order based on the user's requirements, the service characteristics, and the states of the available resources, which are received to select resources. Equation 1 represents an example of a resource management algorithm used in the calculation of the priority order of the available resources:

F(x)=α*f(u)+β*g(s)+γ*h(r) (1)

where x=1 . . . n, (x denotes a resource),

0≦α≦1, 0≦β≦1, 0≦γ≦1, α+β+γ=1

where F(x) denotes a resource performance index that represents a maximum performance that can be exhibited by each of the resources on the network, f(u) denotes a function that classifies user's requirements according to the priority order and quantifies the user's requirements, g(s) denotes a function that quantifies the characteristics of a service to be performed on allocated resources, and h(r) denotes a function that quantifies the states of the resources.

According to Equation 1, in the present invention, a list of resources is produced in a descending order of size of the value of F(x) is produced, and thus the resources are sequentially allocated according to the order. Thus, suitable resources can be selected in collective consideration of the users' requirements, the characteristics of services, and the states of the resources.

The adaptive control of the weights of the reflection of the requirements for resource selection in the future Internet in operation S251 of FIG. 2 will now be described in conjunction with the resource management algorithm of Equation 1.

To select optimal resources, the users' requirements, the characteristics of test services, and the states of the resources are quantified, in operations S310 through S330. The quantifications of the users' requirements, the characteristics of test services, and the states of the resources are represented as f(u), g(s), and h(r), respectively, in Equation 1. The quantifications may be performed according to a technique of allocating data in distributed environments. In an embodiment of quantifying resource states, the performance of a resource is quantified by multiplying a measured performance value of the resource, for example, a measured CPU performance value of a PC, and a network bandwidth by an appropriate coefficient. The embodiment may be expressed in the numerical formula “C1*CPU performance+C2*BW performance”.

In operation S340, initial values of α, β, and γ are determined to reflect information about the quantifications of the users' requirements, the characteristics of test services, and the states of the resources. The initial values of α, β, and γ may be input by a user or may be pre-set as default values. For example, the initial values of α, β, and γ may be set to be 0.4, 0.3, and 0.3, respectively. The present invention is not limited thereto, and various changes may be made.

When the initial values of α, β, and γ are determined, the value of F(x), which is a resource performance index value, is calculated for each of a plurality of resources x on a network, the calculated values are arranged in descending order, and as many resources as the number of resources required by a user to be allocated are allocated by the resource management server 120, in operation S350. In operation S360, it is determined whether a sum of F(x) values for the allocated resources is smaller than or equal to a resource ticket possessed by the user. If the sum of the F(x) values for the allocated resources is smaller than or equal to the resource ticket, the resources are finally allocated to the user. On the other hand, if the sum of the F(x) values for the allocated resources is greater than the resource ticket, the F(x) values are adaptively re-calculated by controlling the initial values of α, β, and γ, which are parameters for controlling the weights of reflection of the functions f(u), g(s), and h(r) used in the calculation of the F(x) values, in operation S351. For example, when a user requests a resource management system to allocate 10 resources, if a sum of the costs of the requested resources is less than or equal to a ticket possessed by the user, the requested resources are allocated. Otherwise, other resources are allocated by controlling the weights of reflection.

In the present invention, when a virtual network environment is established using resources on a network in order for a user to perform an arbitrary test service in the future Internet that is emerging as a replacement of the current Internet, resources having characteristics desired by the user are selected from among a number of resources on the network, and a resource capable of exhibiting an optimum performance is effectively selected from the selected resources. According to the present invention, resources that satisfy various requirements of users can be effectively selected and allocated in the future Internet.

The invention can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of adaptively managing resources in the Internet, the method comprising:
ascertaining users' requirements, service characteristics, and resource states and arranging the users' requirements, the service characteristics, and the resource states in priority order;
calculating a resource performance index by reflecting the arranged status of the users' requirements, the service characteristics, and the resource states, wherein the resource performance index represents a maximum performance capable of being exhibited by each of a plurality of resources on a network; and
allocating resources by comparing a user resource ticket with the resource performance index, wherein the user resource ticket represents a cost that can be afforded by the user for resource usage.

2. The method of claim 1, wherein in the allocating of the resources, if the user resource ticket is equal to or greater than the value of the resource performance index, the resources are allocated, and if the user resource ticket is less than the value of the resource performance index, the calculating of the resource performance indices is re-performed, wherein the proportions of each of the users' requirements, the service characteristics, and the resource states are adjusted.

3. The method of claim 1, wherein the users' requirements comprise a user resource ticket and QoS requirements which are received from the user, and further comprise at least one from among a Mean Time To Failure (MTTF) of resources and the time at which the resources of the user are used.

4. The method of claim 1, wherein the service characteristics comprise at least one among delay information, bandwidth information, loss information of the resources, a resource ticket representing a cost for resource usage, a time when resource allocation can be performed, and characteristics of a physical layer, Layer 1, to an application layer, Layer 7

5. The method of claim 1, wherein in the allocating of the resources, if the user resource ticket is equal to or greater than the value of the resource performance index, the resources are allocated sequentially in a descending order of the value of the resource performance indices.

6. The method of claim 1, wherein in the calculating of the resource performance indices, the resource performance indices are calculated according to a resource management algorithm, the resource management algorithm being expressed in the following equation:
F(x)=α*f(u)+β*g(s)+γ*h(r), 0≦α≦1, 0≦β≦1, 0≦γ≦1, α+β+γ=1
where F(x) denotes a resource performance index, x denotes a resource (x=1 . . . n), f(u) denotes a function that classifies the user's requirements according to the priority order and quantifies the user's requirements, g(s) denotes a function that quantifies the characteristics of a service to be performed on allocated resources, and h(r) denotes a function that quantifies the resource states.

7. The method of claim 6, wherein if the user resource ticket is less than the value of the resource performance index, the values of α, β, and γ are controlled.

8. A server for adaptively managing resources in the Internet, the server comprising:
a collection unit collecting information about users' requirements, service characteristics, and resource states and setting the users' requirements, the service characteristics, and the resource states according to a priority order;
an optimal resource selection unit calculating a resource performance index representing a maximum performance capable of being exhibited by each of a plurality of resources on a network, according to a resource management algorithm based on the information collected by the collection unit; and
an optimal resource allocation unit allocating resources by comparing a resource ticket possessed by a user, which represents a cost that can be afforded by the user, with a value of the resource performance index.

9. The server of claim 8, wherein if the user resource ticket is equal to or greater than the value of the resource performance index, the optimal resource allocation unit allocates the resources, and if the user resource ticket is less than the value of the resource performance index, the optimal resource selection unit controls the proportions of each of the users' requirements, the service characteristics, and the resource states in the resource management algorithm.

10. The server of claim 8, wherein the optimal resource allocation unit is connected to resources selected by the optimal resource selection unit and allocates the selected resources to the user.
